(19) United States
(12) Patent Application Publication
(10) Pub. No.: US 2010/0289231 A1
(43) Pub. Date: Nov. 18, 2010

(54) Ski add-on kit for fitting under the wheels of baby strollers

(76) Inventor: Stephane Huot, Montreal (CA)

Correspondence Address: Stephane Huot, 3591, Gouin E. #106, Montreal, QC, H1H 5V7, CA

(21) Appl. No.: 12/779,798

(22) Filed: May 13, 2010

(30) Foreign Application Priority Data
May 14, 2009 (GB) 0908274.4

(51) Int. Cl. B62B 17/02

(52) U.S. Cl. 280/13

(57) ABSTRACT

A ski add-on kit for fitting under the wheels of baby strollers generally comprises an elongated panel member including a front spatula portion and a rear spatula portion, wherein the spatula portions are formed at an angle to a main surface of the panel member, and an elongated guide slot; a pair of wheel support members adapted to receive and hold a wheel member, wherein the wheel support members are adapted to slide and be releasably held within the guide slot in order to be adapted to releasably hold the wheel member securely therebetween, such that the wheel member can then be supported upon the panel member and slide smoothly along slippery, granular, or other unstable surfaces.

This application claims priority based on request GB 0908274.4 filed May 14, 2009

### FIELD OF THE INVENTION

The present invention relates generally to add on kits but more particularly to a ski kit to be adapted to existing baby strollers.

### BACKGROUND OF THE INVENTION

Winters add their own set of problems to activities we take for granted. Moving a baby stroller is an easy task on a hard surface but becomes quit a problem when moving on a soft slippery surface such as snow, or even sand. Although there exist strollers with skis, there are no practical, simple and reliable ways to convert existing strollers into ski strollers.

### SUMMARY OF THE INVENTION

In view of the foregoing disadvantages inherent in the known devices now present in the prior art, the present invention, which will be described subsequently in greater detail, is to provide objects and advantages which are:

To provide for a practical, simple and reliable ways to convert existing strollers into ski strollers so that they can be used on slippery, granular, or other unstable surfaces such as snow or ice.

Another advantage of this invention is to provide for a way to easily adjust the ski add on onto a variety of wheel diameters and width so as to be as universal as possible.

To attain these ends, the present invention generally comprises an elongated panel member including a front spatula portion and a rear spatula portion, wherein the spatula portions are formed at an angle to a main surface of the panel member, and an elongated guide slot; a pair of wheel support members adapted to receive and hold a wheel member, wherein the wheel support members are adapted to slide and be releasably held within the guide slot in order to be adapted to releasably hold the wheel member securely therebetween, such that the wheel member can then be supported upon the panel member and slide smoothly along slippery, granular, or other unstable surfaces.

In a preferred embodiment, the ski add-on kit has its panel member ski-shaped.

The angles of the spatula members with respect to the panel member are formed in the same direction with respect to the main surface of the panel member.

A strap member is releasably connected to opposite side portions of the panel member, and is adapted to releasably hold the wheel member firmly against the main surface of the panel member.

The ski add-on kit has one of the releasable connections between the strap member and the panel member is formed as a connector, and the second as a strap clip.

The wheel support members are independently and removably locked in place at chosen positions along the guide slot using releasable bolts.

Each of the pair of wheel support members are respectively formed with a V-channel therein; the V-channels being adapted to face each other and hold respective portions of the wheel member snugly therein.

Each of the pair of wheel support members includes a bend therein adapted to more securely releasably hold respective portions of the wheel member snugly therein.

A combination of a wheeled carriage and a ski add-on kit hs a wheeled carriage having at least one wheel member; and at least one ski member, wherein each ski member comprises an elongated panel member including a front spatula portion and a rear spatula portion, wherein the spatula portions are formed at an angle to a main surface of the panel member, and an elongated guide slot; a pair of wheel support members adapted to receive and hold a respective one of the at least one wheel member, wherein the wheel support members are adapted to slide and be releasably held within the guide slot in order to be adapted to releasably hold the respective one of the at least one wheel member securely therebetween, such that each of the at least one wheel member can then be supported upon respective panel members and thereby the wheeled carriage can slide smoothly along slippery, granular, or other unstable surfaces.

A method of converting a wheeled carriage into a slideable carriage comprising the steps of providing a ski add-on kit comprising at least one ski member, wherein each ski member comprises an elongated panel member including a front spatula portion and a rear spatula portion, wherein the spatula portions are formed at an angle to a main surface of the panel member, and an elongated guide slot; a pair of wheel support members adapted to receive and hold a respective one of the at least one wheel member, wherein the wheel support members are adapted to slide and be releasably held within the guide slot in order to be adapted to releasably hold the respective one of the at least one wheel member securely therebetween, such that a ski member is attached to each wheel of the wheeled carriage such that the wheeled carriage can then slide smoothly along slippery, granular, or other unstable surfaces.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric view of the invention.

FIG. 2 Top view of the invention.

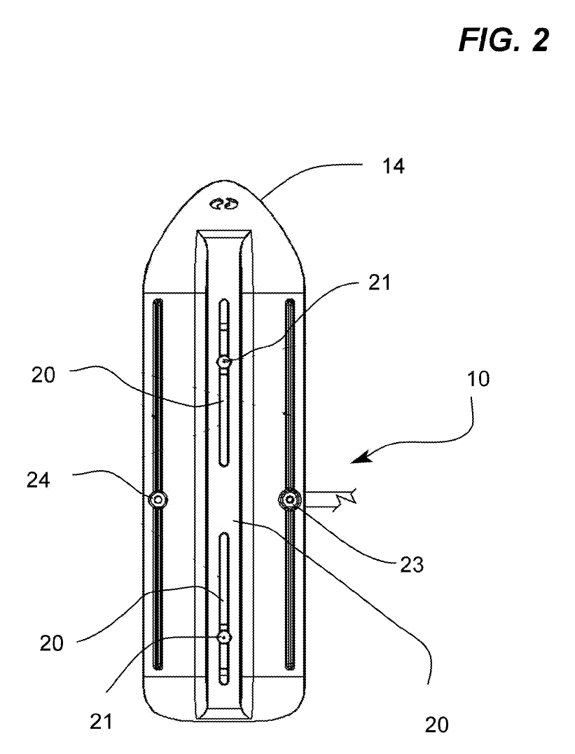

FIG. 3 Isometric view when used on double wheels.

FIG. 4 Isometric view of the invention in context.

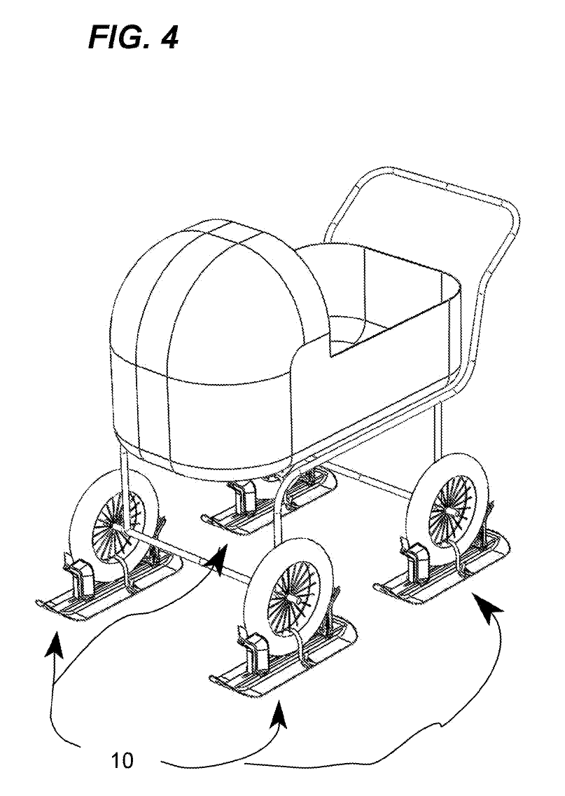

### DETAILED DESCRIPTION OF THE PREFERRED EMBODIMENT

A ski add on kit (10) for sliding forward and backward on snow has a ski shaped member (12) so named because it is defined as an elongated panel member (15) having a main surface (17) from which integrally extend a front spatula (14) portion and a rear spatula portion (16).

A pair of wheel supports (18) connect a wheel (26) to the ski shaped member (12) by way of a wheel support guide slot (20) extending integrally from the ski shaped member (12). A strap portion (22)—attached at one of its end to the ski shaped member (12) by way of a connector (23) and releasably attached to a strap clip (24) at its opposite end—attaches the wheel to the body (12).

The slot (20), by allowing to vary the distance between both wheel supports (18), permits a variety of wheel (26) diameters to be fitted between the wheel supports. Once a wheel (26) is fitted, bolts (21) are tightened and the strap (22) is tightened.

A bend (19) within the wheel support (18) in combination with the wheel support guide slot (20) allow for a large variety of wheel (26) diameters to be attached thereto. The “V” channel configuration of the wheel support (18) allows for a variety of wheel width to be centered and securely attached thereto.

Generally, wheels of 3″ to 18½″ in diameter and of up to 2½″ wide are used on strollers and can all be fitted on the ski add on kit (10), which makes it virtually universal.

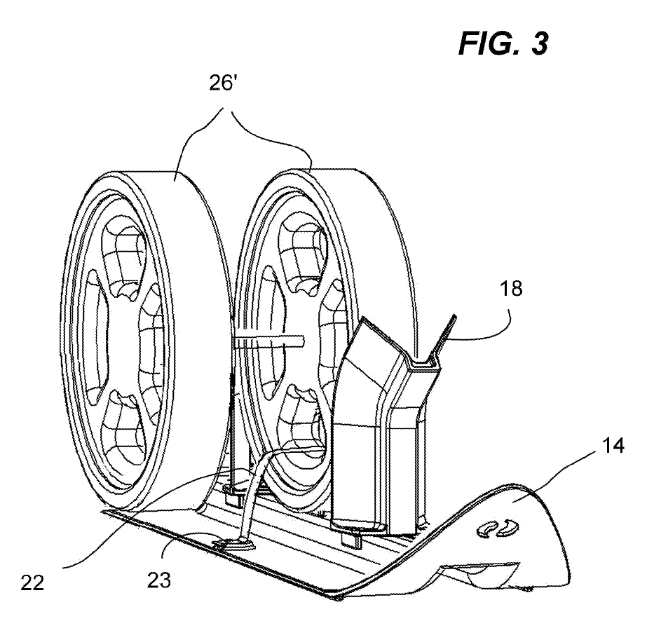

Also, the ski add on kit (10) allows for double wheels (26′) to be installed as well, as shown in FIG. 3.

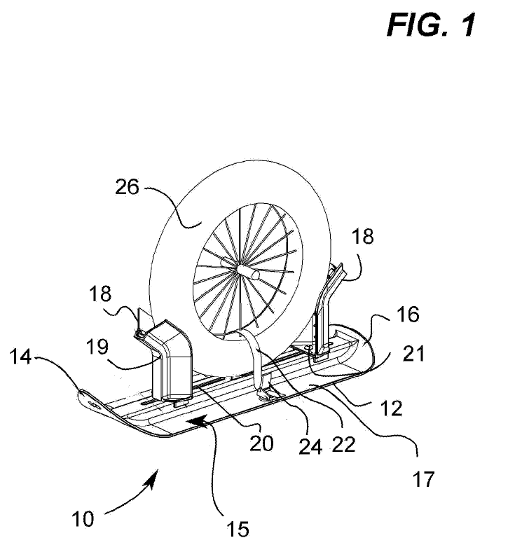

In order to use the ski add on kit (10), a user adjusts the wheel supports (18) so that that the wheel (26) is properly fitted in, then tightens the bolts (21), and finally, tightens the strap (22) around the hub of the wheel (26) as shown in FIG. 1 and repeats the procedure for each wheel (26). To remove the ski add on (10), the strap (22) is removed but the wheel supports (18) remain as is, ready for the next installation.

As to a further discussion of the manner of usage and operation of the present invention, the same should be apparent from the above description. Features found to be useful on standard skis and snowboards are included in the design of the ski add on kit (10) to ensure the best snow ride possible. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A ski add-on kit for wheel members comprising an elongated panel member including a front spatula portion and a rear spatula portion, wherein said spatula portions are formed at an angle to a main surface of said panel member, and an elongated guide slot; a pair of wheel support members adapted to receive and hold a wheel member, wherein said wheel support members are adapted to slide and be releasably held within said guide slot in order to be adapted to releasably hold said wheel member securely therebetween, such that said wheel member can then be supported upon said panel member and slide smoothly along slippery, granular, or other unstable surfaces.

2. The ski add-on kit of claim 1, wherein said panel member is ski-shaped.

3. The ski add-on kit of claim 1, wherein the angles of said spatula members with respect to said panel member are formed in the same direction with respect to said main surface of said panel member.

4. The ski add-on kit of claim 1, further comprising a strap member releasably connected to opposite side portions of said panel member, and is adapted to releasably hold said wheel member firmly against said main surface of said panel member.

5. The ski add-on kit of claim 4, wherein one of the releasable connections between said strap member and said panel member is formed as a connector, and the second as a strap clip.

6. The ski add-on kit of claim 1, wherein said wheel support members are independently and removably locked in place at chosen positions along said guide slot using releasable bolts.

7. The ski add-on kit of claim 1, wherein each of said pair of wheel support members are respectively formed with a V-channel therein; said V-channels being adapted to face each other and hold respective portions of said wheel member snugly therein.

8. The ski add-on kit of claim 7, wherein each of said pair of wheel support members includes a bend therein adapted to more securely releasably hold respective portions of said wheel member snugly therein.

9. A combination of a wheeled carriage and a ski add-on kit comprising a wheeled carriage having at least one wheel member; and at least one ski member, wherein each ski member comprises an elongated panel member including a front spatula portion and a rear spatula portion, wherein said spatula portions are formed at an angle to a main surface of said panel member, and an elongated guide slot; a pair of wheel support members adapted to receive and hold a respective one of said at least one wheel member, wherein said wheel support members are adapted to slide and be releasably held within said guide slot in order to be adapted to releasably hold said respective one of said at least one wheel member securely therebetween, such that each of said at least one wheel member can then be supported upon respective panel members and thereby said wheeled carriage can slide smoothly along slippery, granular, or other unstable surfaces.

10. The ski add-on kit of claim 9, wherein each said panel members is ski-shaped.

11. The ski add-on kit of claim 9, wherein the angles of said spatula members with respect to each said panel member are formed in the same direction with respect to said main surface of said panel member.

12. The ski add-on kit of claim 9, further comprising a strap member releasably connected to opposite side portions of each respective panel member, and is adapted to releasable hold said wheel member firmly against said main surface of each respective panel member.

13. The ski add-on kit of claim 12, wherein one of the releasable connections between said strap member and said panel member is formed as a connector, and the second as a strap clip.

14. The ski add-on kit of claim 9, wherein said wheel support members are independently and removably locked in place at chosen positions along said guide slot using releasable bolts.

15. The ski add-on kit of claim 9, wherein each of said pair of wheel support members are respectively formed with a V-channel therein; said V-channels being adapted to face each other and hold respective portions of said wheel member snugly therein.

16. The ski add-on kit of claim 15, wherein each of said pair of wheel support members includes a bend therein adapted to more securely releasably hold respective portions of said wheel member snugly therein.

17. A method of converting a wheeled carriage into a slideable carriage comprising the steps of providing a ski add-on kit comprising at least one ski member, wherein each ski member comprises an elongated panel member including a front spatula portion and a rear spatula portion, wherein said spatula portions are formed at an angle to a main surface of said panel member, and an elongated guide slot; a pair of wheel support members adapted to receive and hold a respective one of said at least one wheel member, wherein said wheel support members are adapted to slide and be releasably held within said guide slot in order to be adapted to releasably hold said respective one of said at least one wheel member securely therebetween, such that a ski member is attached to each wheel of said wheeled carriage such that said wheeled carriage can then slide smoothly along slippery, granular, or other unstable surfaces.
